(19) United States
(12) Patent Application Publication
(10) Pub. No.: US 2011/0180582 A1
(43) Pub. Date: Jul. 28, 2011

(54) PRESSURE-TEMPERATURE ABACUS AND A FUEL CARTRIDGE, A DEVICE FOR TRANSFERRING FUEL AND A HAND FASTENING TOOL WITH A PRESSURE SENSOR

(75) Inventors: Pierre CORDEIRO, Livron Sur Drome (FR); Jean-Michel DREVETON, Valence (FR)

(73) Assignee: SOCIETE DE PROSPECTION ET D'INVENTIONS TECHNIQUES SPIT, Bourg Les Valence (FR)

(21) Appl. No.: 13/012,450

(22) Filed: Jan. 24, 2011

(30) Foreign Application Priority Data
Jan. 26, 2010 (FR) 1050527

(51) Int. Cl. B25C 1/16

(52) U.S. Cl. 227/9

(57) ABSTRACT

The assembly comprises a fuel cartridge, for driving fastening elements in an internal combustion engine hand tool, and at least an abacus relative to a fuel of a plurality of curves representing the pressure of said fuel as a function of the temperature thereof and relating to a same plurality of filling rates of said fuel in the cartridge. The cartridge comprises a pressure sensor adapted for measuring the fuel pressure in the cartridge. The fastening tool comprises, between a transferring device and the housing of the cartridge, a pressure sensor adapted for measuring the fuel pressure.

The field of this invention relates to internal combustion engine hand tools, intended for driving fastening elements in a supporting material under the action of firing a driving fuel in a combustion chamber of the internal combustion engine, the fuel having been transferred in the combustion chamber from a fuel cartridge housed in the tools. Tools of such a type include, for example, nailers, staplers.

One of the problems of such tools is that of knowing the filling level of the fuel cartridge.

Generally, such a cartridge comprises an internal pocket adapted to be filled with fuel. For ejecting fuel out of the pocket, the pocket is opened partially immerged in a propelling liquid exerting some pressure on the pocket, resulting in the fuel coming out. As an example, the pressure exerted by the propelling liquid could be 4 atmospheres. Above the liquid, there is essentially air at a pressure of 1 atmosphere.

Now, the Applicant in an attempt to overcome the problem of the filling level, found out that the more the pocket of a cartridge was filled, the more the pressure increased as exerted by the air on the pocket, the pressure of 1 atmosphere corresponding to an empty pocket. As the pocket is filled, the air volume decreases, resulting in the pressure thereof being increased. Thus, the pressure exerted on the pocket could range from (4+1) 5 atmospheres, with an empty pocket at [4+(1×4)] 8 atmospheres, whereas with full pocket, the pressure drops to 5 atmospheres as the pocket becomes empty of its driving fuel.

Under such conditions, the Applicant proposed his invention, still suggested by the Mariotte's law, according to which, at constant volume, the pressure and temperature of a fluid are in an equally constant ratio.

Thus, this invention first relates to a fuel cartridge assembly, for driving fastening elements in an internal combustion engine hand tool, and at least one abacus, relating to a fuel, of a plurality of curves representative of the pressure of said fuel as a function of the temperature thereof and relating to a same plurality of filling rates of said cartridge fuel.

For the fuel being considered, knowing the fuel pressure in the cartridge and the temperature thereof allows to know the filling rate of the cartridge.

A series of abacuses could then be easily provided, relating to a set of different fuels able to fill the cartridge.

Closely linked with the above claimed set, the Applicant further provides a fuel cartridge for driving fastening elements in an internal combustion engine hand tool, characterized in that it comprises a pressure sensor adapted for measuring the fuel pressure in the cartridge.

In combination with an abacus of the invention and knowing the temperature, the filling rate of the cartridge can thus be immediately known.

There is further provided a device for transferring fuel from a fuel cartridge to the combustion chamber of an internal combustion engine hand tool, for driving fastening elements in a supporting material, characterized in that it comprises a pressure sensor adapted for measuring the fuel pressure.

Knowing the pressure in the transferring device, and the temperature thereof as well, thus the pressure in the cartridge is also known and hence the filling rate thereof.

A transferring device could include a solenoid valve or a piezoelectric injecting device.

There is also provided, in the present application, and within the context of this unique concept for determining the filling rate of driving fuel in a fuel cartridge through determining the pressure thereof and hence, the temperature thereof, an internal combustion engine hand fastening tool, for driving in a supporting material fastening elements, comprising a housing for receiving a cartridge of driving fuel, a combustion chamber, adapted for receiving the driving fuel of the cartridge, with means for firing the fuel in the chamber, a temperature sensor on the tool and a device for transferring fuel from the cartridge in the combustion chamber connected to the cartridge housing through a fuel transmission passage, said tool being characterized in that it comprises between the transferring device and the cartridge housing, on said passage, a pressure sensor adapted for measuring the pressure of the fuel.

Knowing the pressure of fuel between the cartridge and the transferring device as well as the temperature, the pressure in the cartridge is therefore also known and hence, the filling rate thereof.

This invention will be better understood by means of the following description, with reference to the appended drawing in which:

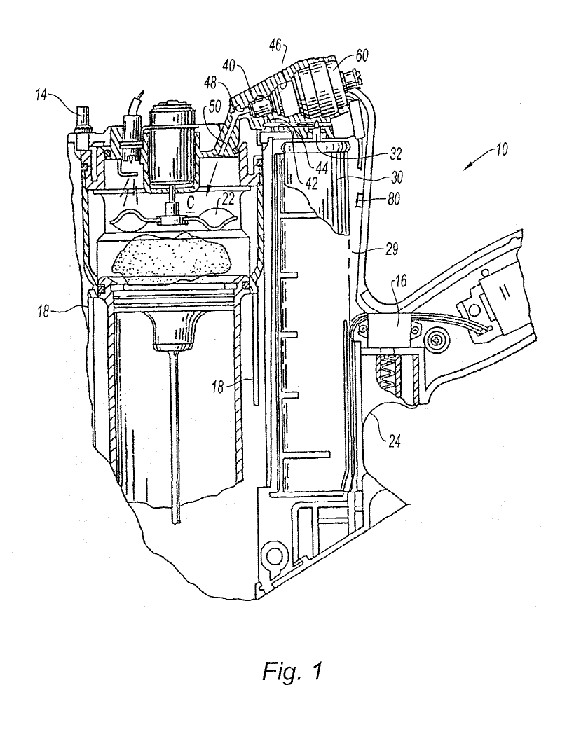

FIG. 1 shows a longitudinal sectional view of an internal combustion engine hand fastening tool, with a fuel cartridge;

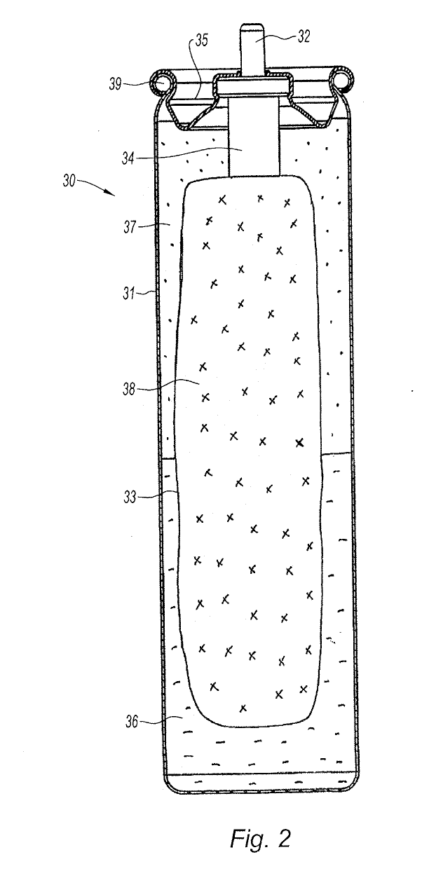

FIG. 2 shows a sectional view of a full fuel cartridge;

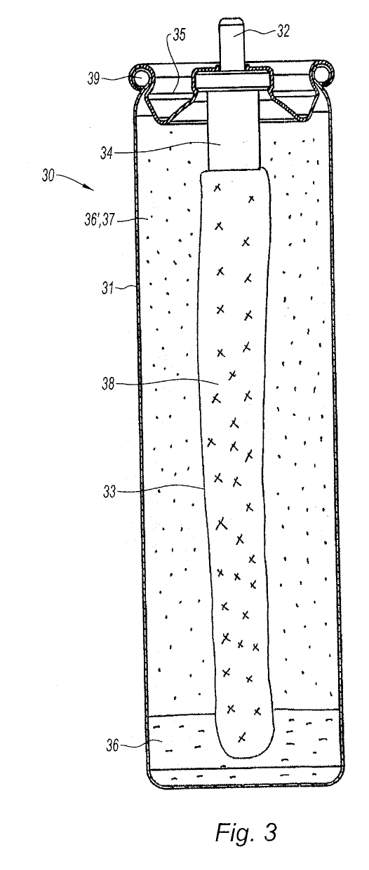

FIG. 3 shows a sectional view of the cartridge on FIG. 1, being nearly empty;

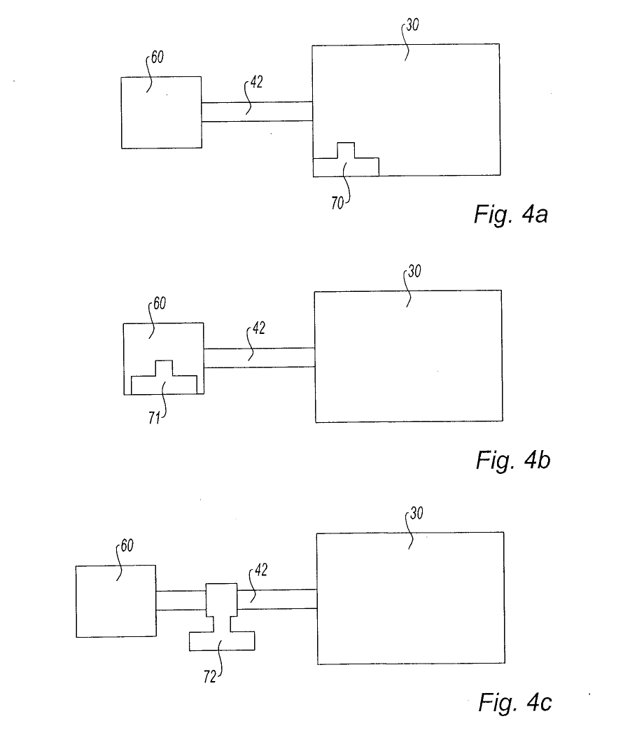

FIGS. 4A, 4B, 4C are schematic illustrations of a assembly comprising a fuel cartridge and a solenoid valve for transferring the fuel from the cartridge to the combustion chamber of a fastening tool, as shown on FIG. 1, with a pressure sensor respectively in the cartridge, the solenoid valve and between both of them;

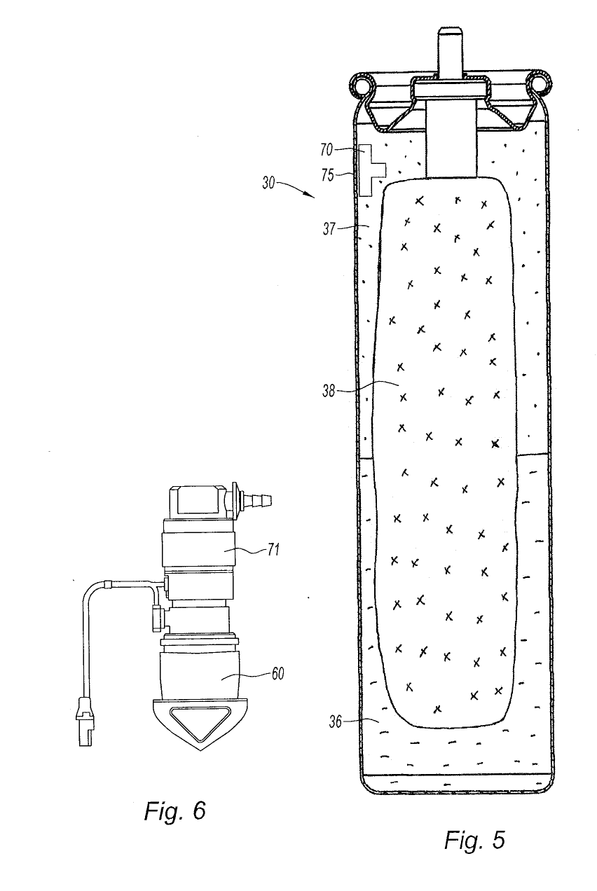

FIG. 5 shows a sectional view of the cartridge on FIGS. 2 and 3, with a pressure sensor inside the cartridge;

FIG. 6 illustrates a view of a solenoid valve, with an integrated pressure sensor, and

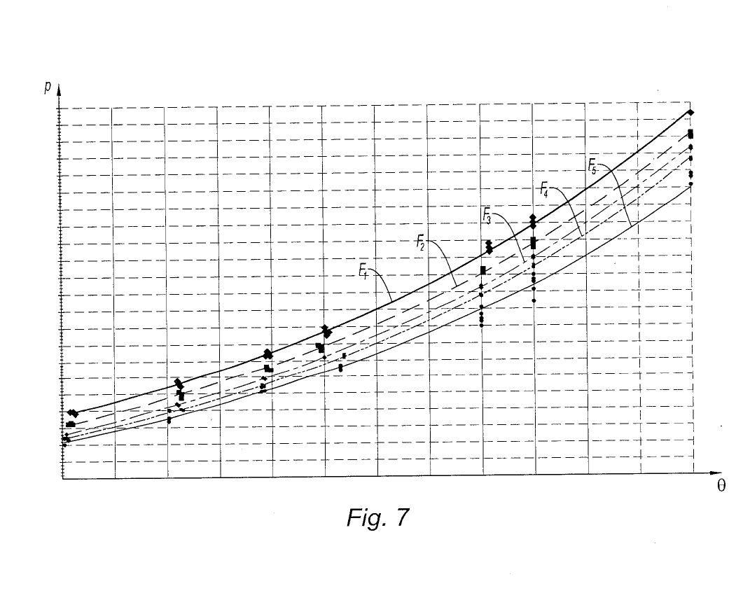

FIG. 7 is an abacus, relating to a fuel of a cartridge, of pressure curves p as a function of the temperature θ for a plurality of filling rates of the cartridge.

With reference to FIG. 1, an internal combustion engine hand fastening tool 10 comprises, in addition to a battery, not shown on the figure, a firing system comprising, amongst other elements, a head switch 14 and a triggering switch 16. The fuel supply system cooperates with the firing system so that the fuel is able to flow into a combustion chamber C of the tool 10 for some time interval after the head switch 14 has been put on and so that the fuel flows in the combustion chamber C for some time interval after the triggering switch 16 has been put on.

The head switch 14 is normally opened and is arranged for being closed, as known, by a movable element 18 of a known type when a contacting element of a sensor of a known type is in abutment against a support adapted for receiving the fastening element. When the sensor is in abutment, the movable element 18 closes the combustion chamber C, wherein, here a fan 22 of a known type can be actuated. Preferably, the head switch 14 is a photoelectric switch.

There is provided a temperature sensor 80 on the tool, and, here on the housing, or shell, 40, thereof, in the cartridge housing, for being arranged in the vicinity of the cartridge. In such a case, this is a thermistor.

The triggering switch 16 should also be closed when the head switch 14 is closed, so that the firing system is able to fire the fuel into the combustion chamber C. A hand trigger 24 is provided for closing the triggering switch 16.

In the tool 10, the fuel is here a hydrocarbon coming out in a liquid state from a pressurized cartridge 30 of a known type. The cartridge 30 has an outlet mouthpiece 32, that should be vigorously depressed so as to allow the fuel to flow out of the cartridge 30 through the outlet mouthpiece 32.

The tool 10 is arranged so that the outlet mouthpiece 32 be depressed when the cartridge 30 is inserted in the tool 10. Thus, the tool 10 comprises the shell 40, with a housing 29 wherein the cartridge 30 is inserted. The shell 40 has a recess 46, the shape of which enables to accommodate a fuel injecting device 60, here a solenoid valve. The shell 40 comprises a network of passage ducts 42, 44 through which the fuel hydrocarbon flows coming out of the cartridge 30 through the outlet mouthpiece 32. The outlet mouthpiece 32 opens into the passage duct 42 when the cartridge 30 is inserted in the tool 10. The passage duct 44 actually extends the passage duct 42 of the shell 40 in the injecting device 60. The injecting device 60 comprises a retaining chamber 48, wherein the passage duct 44 opens, a chamber 48 ending in a nozzle 50, plugged or not by a needle. The nozzle 50 communicates with the combustion chamber C.

The fuel supply system comprises the fuel injecting device 60 mounted in the recess 46. The fuel injecting device 60 is arranged for injecting the fuel in the combustion chamber C during a predetermined time interval for thereby controlling the volume of fuel being injected. The time interval varies with the room temperature and the room pressure.

Referring to FIGS. 2 and 3, the cartridge 30 comprises a cylindrically-shaped shell 31 wherein there is arranged a flexible pocket 33, more or less filled with fuel 38, to which there is sealed a tightening mechanism 34 wherein there is slidably mounted, against the action of a spring, the outlet mouthpiece 32 projecting out of a cup 35 crimped on the shell 31, at the level of a bumper 39. The inner space of the shell 31 surrounding the pocket 33 is partially occupied by a propelling liquid 36, exerting a pressure on the pocket 33, and part essentially by air 37 being located above the propeller 36. Propellant vapours are also located above the propellant 36. When the mouthpiece 32 is being depressed in the tightening mechanism thereof 34, the fuel 38, under the action of the pressure of the propellant 36 as well as the air 37, flows from the cartridge 30 in the solenoid valve 60 through the passage duct 44. When the pocket 33 becomes empty, the space surrounding it increases and the liquid propellant 36 partially switches to a gas phase 36′.

For the fuel located in the pocket 33 of the cartridge 30, the abacus on FIG. 7 has been implemented, collecting a plurality of representative curves, each, of the pressure in the pocket 33 as a function of the temperature, for respectively a plurality of filling rates, in the present case, five.

The first curve F1, from the top, corresponds to a full pocket 33 (FIG. 2), the other curves F2-F5 corresponding to lower filling rates and being decreased through a determined step, the last curve F5, the lower one, thus corresponding to a pocket being nearly empty of its fuel, that is, nearly empty (FIG. 3).

The sensor 80 provides the temperature of the cartridge 30, of the solenoid valve 60 and of linking ducts. Knowing the fuel pressure in the cartridge and the temperature, by means of the sensor 80, thus allows, by means of the abacus F1-F5 to know the filling rate.

For measuring the fuel pressure in the cartridge, several options are possible. Referring to FIGS. 4-6, a pressure sensor 70 could be directly provided in the cartridge 30. A pressure sensor 71 could also be arranged directly in the injecting device 60 (FIGS. 4B and 6). A pressure sensor 72 could be still arranged in the hand tool 10, in the passage duct 42 connecting the cartridge 30 in its housing to the injecting device 60 (FIG. 4C). In the case of the sensor 70 of the cartridge 30, immerged in the (liquid and gas) propellant of the cartridge 38, it is associated to a radiofrequency chip 75 for extracting its signal.

1. A fuel cartridge assembly, for driving fastening elements in an internal combustion engine hand tool, and at least one abacus relative to a fuel of a plurality of curves representing the pressure of said fuel as a function of the temperature thereof and relating to a same plurality of filling rates of said fuel in the cartridge.

2. An assembly according to claim 1, comprising a set of abacuses relating to a set of different fuels able to fill the cartridge.

3. A fuel cartridge for driving fastening elements in an internal combustion engine hand tool, wherein it comprises a pressure sensor adapted for measuring the fuel pressure in the cartridge.

4. A device for transferring fuel from a fuel cartridge to the combustion chamber of an internal combustion engine hand tool, for driving fastening elements in a supporting material, wherein it comprises a pressure sensor adapted for measuring the fuel pressure.

5. A device for transferring fuel being a solenoid valve.

6. An internal combustion engine hand fastening tool, for driving in a supporting material fastening elements, comprising a housing for receiving a cartridge of driving fuel, a combustion chamber C intended for receiving driving fuel from the cartridge, with means for firing the fuel in the chamber, a temperature sensor on the tool and a device for transferring fuel in the cartridge in the combustion chamber connected to the housing of the cartridge through a fuel transmission passage, wherein said tool comprises, between the transferring device and the housing of the cartridge, on said passage, a pressure sensor adapted for measuring the fuel pressure.
